(19) United States
(12) Patent Application Publication
(10) Pub. No.: US 2008/0232562 A1
(43) Pub. Date: Sep. 25, 2008

(54) Telephone Device

(75) Inventor: Satoshi Suzuki, Nagoya-shi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: BROTHER KOGYO KABUSHIKI KAISHA, Nagoya-shi (JP)

(21) Appl. No.: 12/053,339

(22) Filed: Mar. 21, 2008

(30) Foreign Application Priority Data
Mar. 22, 2007 (JP) 2007-074104

(51) Int. Cl. H04M 11/00

(52) U.S. Cl. 379/93.01

(57) ABSTRACT

A telephone device comprises an input unit through which a telephone number is inputted, main storage configured to store the telephone number inputted through the input unit, a processor configured to identify a first number string corresponding to an area code, a second number string corresponding to a local number, and a third number string corresponding to a subscriber number, from the telephone number stored in the main storage, transmit number strings corresponding to the first, second and third number strings as a search word to a search engine on the Internet, and receive a search result according to the transmitted search word, and an output unit configured to output the received search result.

### CROSS-REFERENCE TO RELATED APPLICATION

The present application claims priority from Japanese Patent Application No. 2007-074104, filed on Mar. 22, 2007, the disclosure of which is incorporated herein by reference in its entirety.

### BACKGROUND

1. Field of the Invention

The invention relates to a telephone device configured to display names of parties, abbreviations of the parties' names and information related to the parties (hereinafter, referred to as party's information).

2. Description of Related Art

Telephone devices are known to have a telephone directory function to assist a user in entering a desired telephone number when the user makes a call. When a user receives an incoming call through a telephone device, the telephone device may display party's (caller's) information on a display portion if the telephone device stores, in a telephone directory, a telephone number that is the same as a telephone number of the incoming call transmitted from an exchange.

When a user enters a telephone number, which is the same as a telephone number stored in a telephone directory of a telephone device, by pressing dial keys to make a call, the telephone device may display party's (receiver's) information that is stored in the telephone directory in correspondence with the telephone number.

### SUMMARY OF THE INVENTION

As described above, the telephone numbers and the party's information need to be stored in correspondence with each other in the telephone directory of the telephone device to output the desired party's information on the display portion. However, the user does not always make or receive calls to or from parties whose information are stored in the telephone directory through the telephone device.

The invention provides a telephone device configured to precisely output party's information related to an entered telephone number when a user of the telephone device makes and receives calls.

The invention also provides a device configured to divide a telephone number entered in a telephone device into a plurality of number strings, search for the number strings as a search word through a search engine on the Internet, and output information obtained by the search.

According to an embodiment of the invention, a telephone device may include an input unit through which a telephone number is inputted, main storage configured to store the telephone number inputted through the input unit, a processor configured to identify a first number string corresponding to an area code, a second number string corresponding to a local number, and a third number string corresponding to a subscriber number, from the telephone number stored in the main storage, transmit number strings corresponding to the first, second and third number strings as a search word to a search engine on the Internet, and receive a search result according to the transmitted search word, and an output unit configured to output the received search result.

Accordingly, the telephone device configured to precisely output party's information according to an inputted telephone number when making or receiving a call may be obtained.

Further, a search word that is consistent with an indication manner of telephone numbers displayed on websites on the Internet may be created.

According to an embodiment of the invention, a telephone device may comprise an input unit through which a telephone number is inputted, main storage configured to store the telephone number inputted through the input unit, a processor configured to identify a first number string corresponding to an area code, a second number string corresponding to a local number, and a third number string corresponding to a subscriber number, from the telephone number stored in the main storage, transmit number strings corresponding to the first, second and third number strings as a search word to a search engine on the Internet, make access to a website according to address information identified by a search result based on the transmitted search word, and receive the search result and data transmitted from the website, and an output unit configured to output the received data.

Accordingly, the telephone device configured to precisely output detailed party's information according to an inputted telephone number when making or receiving a call may be obtained.

Further, a search word that is consistent with an indication manner of telephone numbers displayed on websites on the Internet may be created.

Other objects, features, and advantages of the invention will be understood by those skilled in the art from the following detailed description and accompanying drawings.

### BRIEF DESCRIPTION OF THE DRAWINGS

Embodiments of the invention will be described in detail with reference to the following figures in which like elements are labeled with like numbers.

FIG. 1 is a diagram showing a configuration of a multifunctional machine and a network system including the multifunctional machine according to embodiments of the invention.

FIG. 2 illustrates signals to be transmitted to the multifunctional machine from an exchange according to the embodiments of the invention.

FIG. 3 is a flowchart of processing to be performed by a CPU of a multifunctional machine according to a first embodiment of the invention.

FIG. 4 illustrates a display example of search results according to the embodiments of the invention.

FIG. 5 is a flowchart of processing to be performed by a CPU of a multifunctional machine according to a second embodiment of the invention.

FIG. 6 illustrates a display example of a website related to a party according to the embodiments of the invention.

FIG. 7 is a flowchart of processing to be performed by a CPU of a multifunctional machine according to a third embodiment of the invention.

### DETAILED DESCRIPTION OF EMBODIMENTS

The following description will describe a telephone device according to illustrative embodiments of the invention with reference to drawings. It is to be understood that the invention is not restricted to the particular forms shown and described below but may include additional or alternative forms from those described herein without departing from the scope of the aspects of the invention. In particular, various modifications and alterations can be made thereto without departing from the scope of the invention.

It is noted that various connections are set forth between elements in the following description. It is noted that these connections in general and, unless specified otherwise, may be direct or indirect and that this specification is not intended to be limiting in this respect.

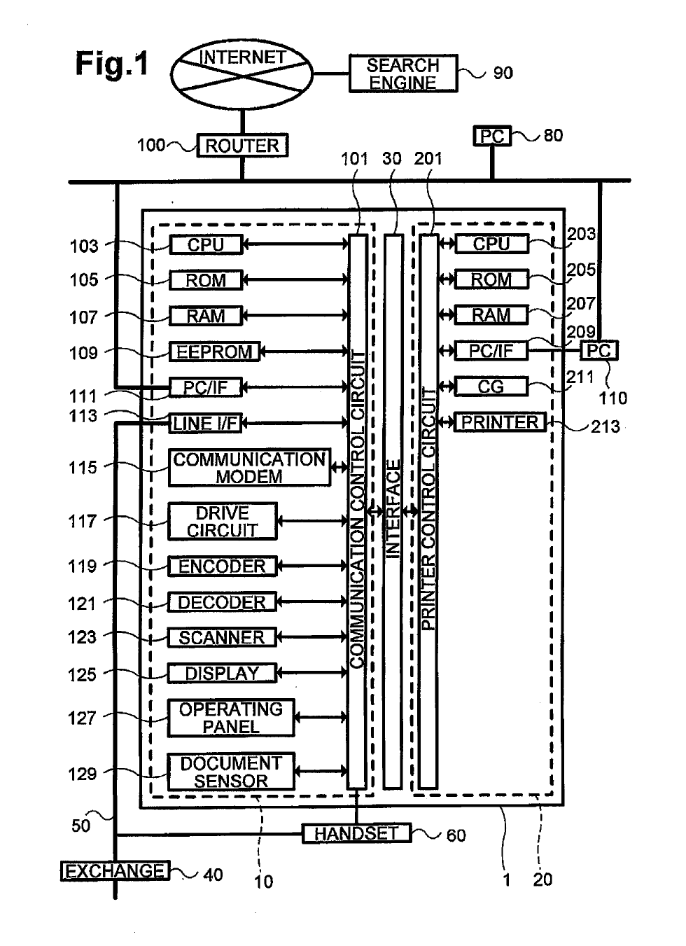

A first embodiment of the invention will be described below. FIG. 1 shows an entire system including a configuration of a so-called multifunctional machine 1 as an example of a telephone device. The multifunctional machine 1 has a facsimile function, a telephone function, a printing function, and a scanning function. The multifunctional machine 1 may be connected to a local area network (LAN) via a personal computer (PC) interface (I/F) 111. The multifunctional machine 1 is configured to perform data communications with a PC 80 on the LAN and with a search engine 90 on the Internet via a router 100.

The multifunctional machine 1 includes a communications unit 10 and a printing unit 20, which are connected with each other via an interface 30. For example, when the multifunctional machine 1 receives print data from the PC 80 on the LAN, the multifunctional machine 1 can output the print data by printing the data on a recording medium by the printing unit 20.

The communications unit 10 includes a communication control circuit 101. The communication control circuit 101 is connected to the following elements as shown in FIG. 1.

A CPU 103 is configured to control the communications unit 10 in accordance with one or more control programs (for executing various processing including the following processing) stored in a ROM 105.

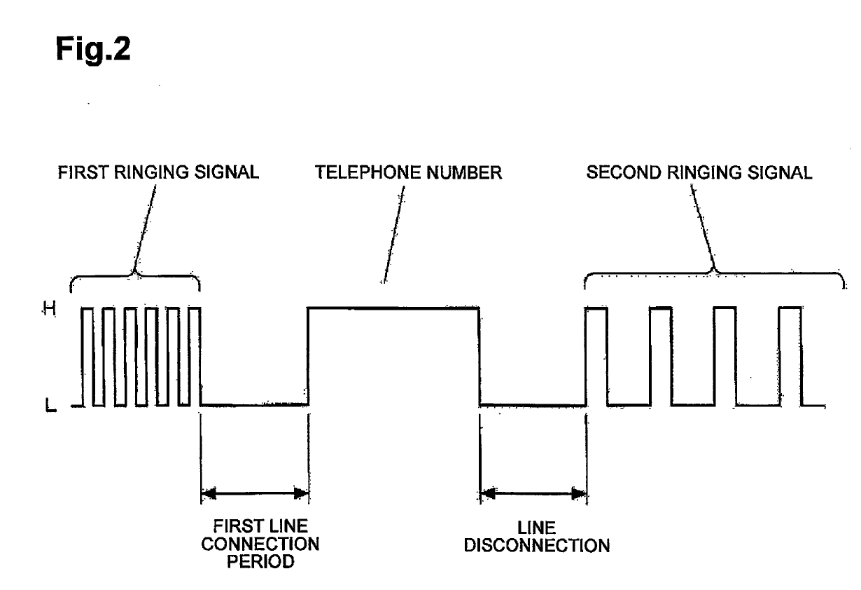

An EEPROM 109 is a nonvolatile memory and functions as a so-called telephone directory by storing names and telephone numbers of parties in association with each other. The EEPROM 109 is also configured to store a line connection condition of when a line interface 113 is connected with an exchange 40 via a public communication line 50 in a communicable state. The line connection condition is used to connect the line when the line interface 113 receives a first ringing signal, which is to be transmitted from the exchange 40 prior to a telephone number. For example, the first ringing signal may have a period of high level (H) for 0.5 seconds, a period of low level (L) for 0.5 seconds, and a frequency of 16 hertz when the signal is transmitted from the exchange 40 during the period of high level (six pulses) (see FIG. 2).

The EEPROM 109 is further configured to store area codes of all areas including an area where the multifunctional machine 1 is installed.

The EEPROM 109 is configured to store a uniform resource locator (URL) of the search engine 90 on the Internet.

The EEPROM 109 stores the telephone numbers and the area codes, for example, in ASCII code.

The line interface 113 includes a data access arrangement (DAA) (not shown) and is configured to directly connect the exchange 40 via the public communication line 50. The line interface 113 is configured to receive a telephone number, a first ringing signal which is to be transmitted prior to the telephone number, and a second ringing signal which is to be transmitted following the telephone number. For example, the second ringing signal may have a period of high level (H) for one second, a period of low level (L) for two seconds, and a frequency of 16 hertz when the signal is transmitted from the exchange 40 during the period of high level (six pulses) (see FIG. 2). The line interface 113 is also configured to control the line connection during reception of the first and second ringing signals.

A communication modem 115 is configured to compress data, which is transmitted and received between the multifunctional machine 1 and a party (not shown), using an encoder 119. The data may include, for example, image data, which is scanned by a scanner 123 and temporarily stored in a RAM 107. The communication modem 115 is also configured to modulate the compressed data and demodulate data transmitted from a party. The data demodulated by the communication modem 115 is decompressed by a decoder 121 and made available.

The communications unit 10 further includes a display 125 and an operating panel 127. The display 125 is configured to display various information to be provided to a user. The operating panel 127 includes various keys, such as selection keys, dial keys, and alphabetical keys. The selection keys are used to input instructions from the user of the multifunctional machine 1, for example, to select specific information from various information displayed on the display 125. The dial keys are used to enter a telephone number to be stored in the EEPROM 109 (the telephone directory) and an area code of the area where the multifunctional machine 1 is installed, or directly enter a desired telephone number when the user makes a call. The alphabetical keys are used to enter the URL of the search engine 90 to be stored in the EEPROM 109. The dial keys may also serve as the alphabetical keys. A telephone number directly entered by the user through the operating panel 127 to make a call is stored in the RAM 107. The communications unit 10 further includes other elements, such as a drive circuit 117 and a document sensor 129. Details in accordance with one example of the invention are shown in FIG. 1.

The printing unit 20 includes a printer control circuit 201. The printer control circuit 201 is connected with a CPU 203, a ROM 205, a RAM 207, a PC interface (I/F) 209, a character generator (CG) 211, and a printer 213. The CPU 203 is configured to control each operation of the printing unit 20. The printing unit 20 is configured to directly connect a PC 110 via the PC interface 209.

Referring to FIG. 2, a signal to be transmitted to the multifunctional machine 1 from the exchange 40 will be described. First, a polarity reversal signal (not shown) is transmitted from the exchange 40 to the multifunctional machine 1, and then a first ringing signal is transmitted. Upon receipt of the first ringing signal, the line interface 113 performs a line connection operation to connect the line between the line interface 113 and the exchange 40 based on the line connection condition stored in the EEPROM 109 in order to receive a telephone number to be transmitted next. The line connection operation is performed during a first line connection period as shown in FIG. 2. The detailed description of the line connection operation will be omitted.

Then, the line interface 113 receives the telephone number from the exchange 40 and stores the received telephone number in the RAM 107. After that, the line interface 113 temporarily disconnects the line between the line interface 113 and the exchange 40 during a period of line disconnection.

The multifunctional machine 1 notifies the user of the multifunctional machine 1 that there is an incoming call by issuing ringing sounds via a speaker (not shown), which is provided in the multifunctional machine 1, upon receipt of the second ringing signal. The line interface 113 performs the line connection operation again when the user lifts a handset 60 of the multifunctional machine 1 in response to the ringing sounds.

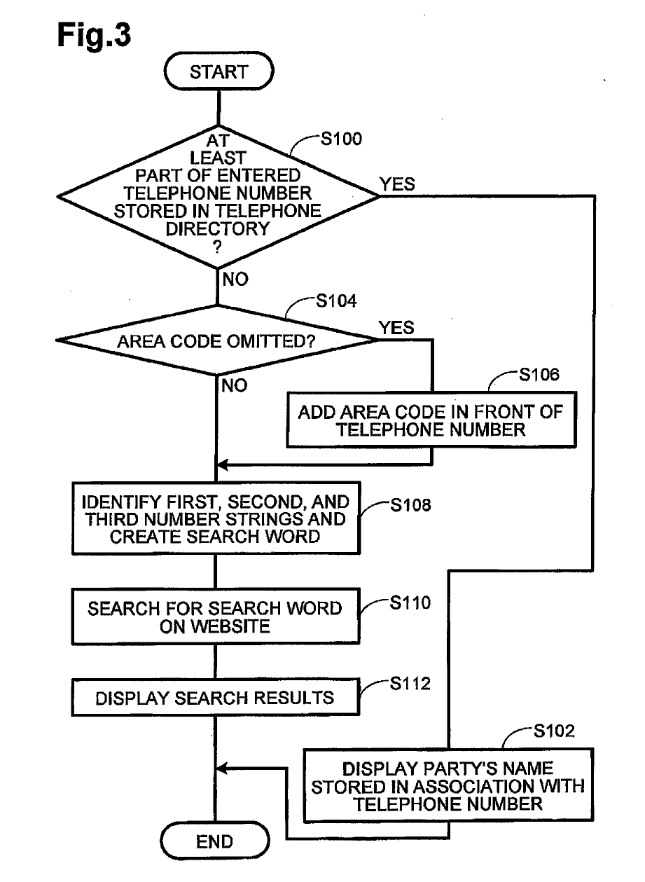

FIG. 3 shows processing to be performed by the CPU 103 when a telephone number is inputted and stored in the RAM 107 through users operation on the operating panel 127 to make a call or upon receipt of an incoming call through the line interface 113. This processing is to be performed parallel to the other processing after the power of the multifunctional machine 1 is turned on.

First, the CPU 103 determines whether a telephone number including a part or the entirety of the telephone number stored in the RAM 107 is stored in a memory area of the telephone directory of the EEPROM 109 (S100).

The case where a telephone number including a part of the telephone number stored in the RAM 107 is stored in the EEPROM 109 is a case where the telephone number stored in the EEPROM 109 includes an area code although the telephone number stored in the RAM 107 does not include an area code. More specifically, for example, a telephone number “1346789” is stored in the RAM 107 and a telephone number “0521346789” is stored in the EEPROM 109.

The case where a telephone number including the entirety of the telephone number stored in the RAM 107 is stored in the EEPROM 109 is a case where the both telephone numbers stored in the RAM 107 and the EEPROM 109 match with each other. More specifically, for example, a telephone number “1346789” is stored in both of the RAM 107 and the EEPROM 109 or a telephone number “0521346789” is stored in both of the RAM 107 and the EEPROM 109.

When the CPU 103 makes an affirmative determination at S100 (S100:YES), flow moves to S102. At S102, the CPU 103 controls the communications unit 10 to display a party's name, which is stored in the EEPROM 109 in association with the telephone number that corresponds to the telephone number stored in the RAM 107, on the display 125.

When the CPU 103 makes a negative determination at S100 (S100:NO), flow moves to S104.

At S104, the CPU 103 determines whether an area code is omitted from the telephone number stored in the RAM 107. A telephone number assigned to a fixed-line telephone device used in Japan contains ten digits. The fixed-line telephone device includes the multifunctional machine 1 of the invention. Therefore, at S104, the CPU 103 determines whether the entered telephone number is a ten-digit number to make the above determination.

When the telephone number stored in the RAM 107 contains less than ten digits, the CPU 103 determines that the area code is omitted from the telephone number (S104:YES), and flow moves to S106. When the telephone number stored in the RAM 107 contains ten digits, the CPU 103 determines that the area code is not omitted from the telephone number (S104:NO) and flow moves to S108.

At S106, the CPU 103 adds an area code, which indicates an area where the multifunctional machine 1 is installed and is stored in the EEPROM 109, in front of the telephone number stored in the RAM 107, and then flow moves to S108. By the processing of S106, the telephone number stored in the RAM 107 is changed to a ten-digit telephone number.

At S108, the CPU 103 identifies a first number string corresponding to an area code, a second number string corresponding to a local number, and a third number string corresponding to a subscriber number, from the telephone number stored in the RAM 107, and creates a search word by using the identified number strings. Then, flow moves to S110.

The identification of the first, second and third number strings in the telephone number to be performed at S108 will be described in detail below. First, the CPU 103 identifies the third number string corresponding to the subscriber number. More specifically, the CPU 103 identifies the last four digits of the telephone number stored in the RAM 107 as the third number string.

Then, the CPU 103 identifies the first number string corresponding to the area code based on the area codes stored in the EEPROM 109 and the telephone number stored in the RAM 107. More specifically, the CPU 103 selects an area code from the area codes stored in the EEPROM 109 and selects a number string having the same digits as the selected area code from a front of the telephone number stored in the RAM 107. Then, the CPU 103 determines whether the selected area code and the selected number string match with each other.

When the selected area code and the selected number string match with each other, the CPU 103 identifies the selected area code as the first number string. When the selected area code and the selected number string do not match with each other, the CPU 103 selects another area code and repeatedly performs the above processing until the CPU 103 identifies the first number string.

Finally, the CPU 103 identifies the remainder of the telephone number, that is, the numbers that have not been identified as either of the first and third number strings, as the second number string corresponding to the local number.

At S110, the CPU 103 reads out the URL of the search engine 90 from the EEPROM 109 and transmits number strings corresponding to the respective first, second and third number strings identified at S108 as a search word, to the search engine 90 identified by the URL. In response to the transmission of the search word, the CPU 103 receives search results from the search engine 90. The search results include abstract information and an URL of each website found based on the search word.

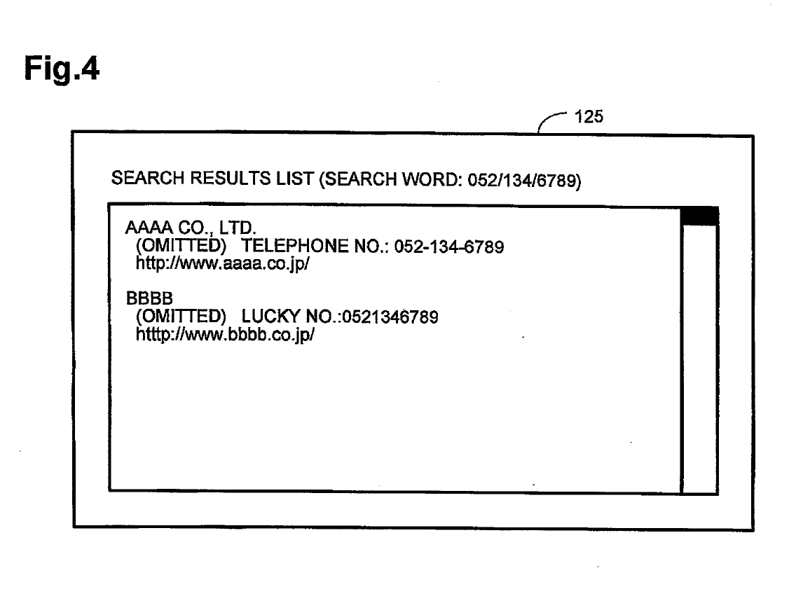

Then, the CPU 103 displays the search results, which have been received at S110, on the display 125 at S112, as shown in FIG. 4, for example.

Optionally, when the telephone number stored in the RAM 107 was inputted by user's operation through the operating panel 127, that is, when the inputted telephone number is to be used for an outgoing call, the communications unit 10 may be configured to make a call (S114) on condition that the search results are displayed on the display 125. Further optionally, when the telephone number stored in the RAM 107 was inputted by the receipt of the telephone number by the line interface 103, that is, when the telephone number was inputted by an incoming call, the communications unit 10 may be configured to make ringing sounds (S114) on condition that the search results are displayed on the display 125. With this structure, information according to a party may be displayed on the display 125 prior to user's operation. In other words, the user of the multifunctional machine 1 is provided with the information, for example, an outgoing call to a specific party or an incoming call from a specific party, before performing operations.

The search results may be printed via the printer 213 of the printing unit 20 with or without displaying the search results on the display 125. The printing of the search results may be useful if the display 125 has a smaller screen size.

According to the above-described structure, for example, a party's name related to a telephone number stored in the RAM 107 may be precisely searched and displayed on the display 125 even if a website contains a telephone number in a manner such as “052-134-6789” or “052(134)6789” (except “0521346789”). That is, if a search word is created as a manner of a telephone number stored in the RAM 107, that is, “0521346789”, a party's name related to a telephone number stored in the RAM 107 may not be searched or may be difficult to be found.

The description has been made, taking the fixed-line telephone device used in Japan as an example, so that the criteria of the determination at S104 is whether the telephone number stored in the RAM 107 is a ten-digit number. However, when the same system is applied to a cellar phone to be used in Japan, the criteria of the determination at S104 may be whether the telephone number stored in the RAM 107 is an 11-digit number. When the same system is applied to telephone devices to be used in foreign countries, the criteria of the determination at S104 may be changed to an appropriate digits number to be used in each country.

At S108, the CPU 103 selects an area code from the area codes stored in the EEPROM 109 and selects a number string having the same digits as the selected area code from a front of a telephone number stored in the RAM 107. Then, the CPU 103 compares the selected area code and the selected number string. The CPU 103 repeatedly performs this processing until the CPU 103 identifies the first number string. This processing may be performed with respect to all of the area codes stored in the EEPROM 109 at a time. In this case, a plurality of pairs of the first and second number strings may be identified with respect to a single third number string. At S110, the CPU 103 transmits search words with respect to all of the pairs of the first and second number strings to the search engine 90 and receives search results with respect to each search word. At S112, each of the search results may be displayed on the display 125, or the search results may be displayed on the display 125 after edited.

As described above, the multifunctional machine 1 is configured to directly transmit number strings corresponding to first, second and third number strings that are obtained by diving a telephone number into an area code, a local number, and a subscriber number, to the search engine 90 as a search word. When the multifunctional machine 1 cannot directly perform data communications with the search engine 90, that is, when the multifunctional machine 1 is directly connected with the PC 110 on the LAN, the multifunctional machine 1 may be configured to transmit the URL of the search engine 90 and the search word to the PC 110 on the LAN to perform a search for the search word via the PC 110 and receive search results via the PC 110. Alternatively, the multifunctional machine 1 may be configured to transmit the URL of the search engine 90 and number strings according to a telephone number stored in the RAM 107 to the PC 110. The first, second and third number strings of the telephone number may be identified in the PC 110, and the search may be performed via the PC 110. Then, the multifunctional machine 1 may be configured to receive the search results from the PC 110.

In this case, the PC 110 may be configured to store the URL of the search engine 90 and transmit number strings corresponding to the first, second and third number strings as a search word to the search engine 90 identified by the URL. In such a case, the URL of the search engine 90 is not transmitted from the multifunctional machine 1 to the PC 110.

When the search is performed via the PC 110, search results may be displayed on a display of the PC 110.

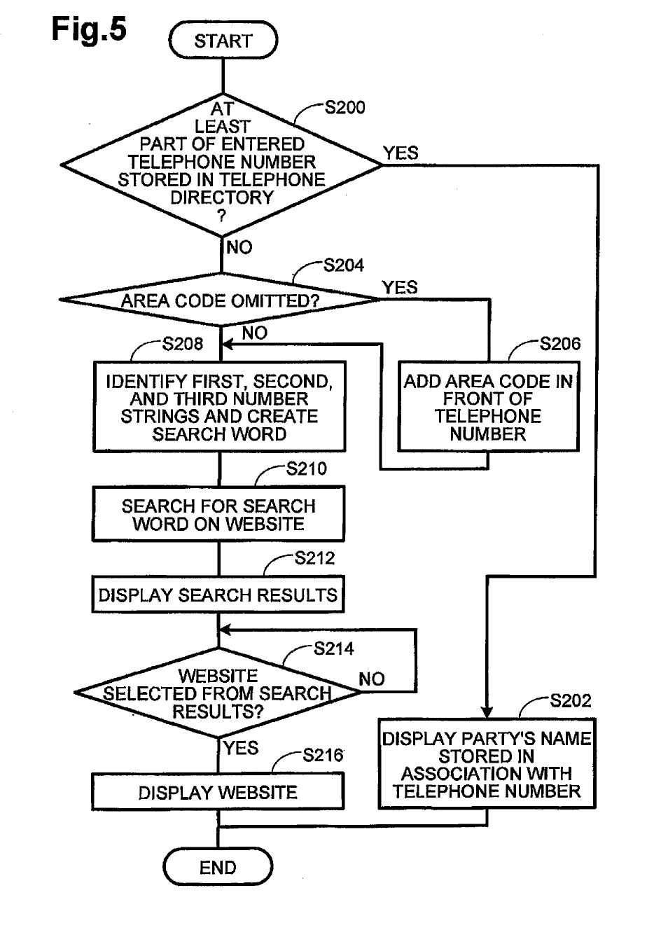

Referring to FIG. 5, processing to be performed by a CPU of a multifunctional machine according to a second embodiment of the invention will be described. The multifunctional machine according to the second embodiment has the same structure as the multifunctional machine 1 according to the first embodiment although performs processing that is different from the processing at S113 of FIG. 3 to be performed by the multifunctional machine 1 according to the first embodiment. Accordingly, like parts and components are designated by the same reference numerals to avoid duplicate descriptions.

First, a CPU 103 of the multifunctional machine 1 performs processing of S200 to S212, which are the same as those of S100 to S112 of FIG. 3.

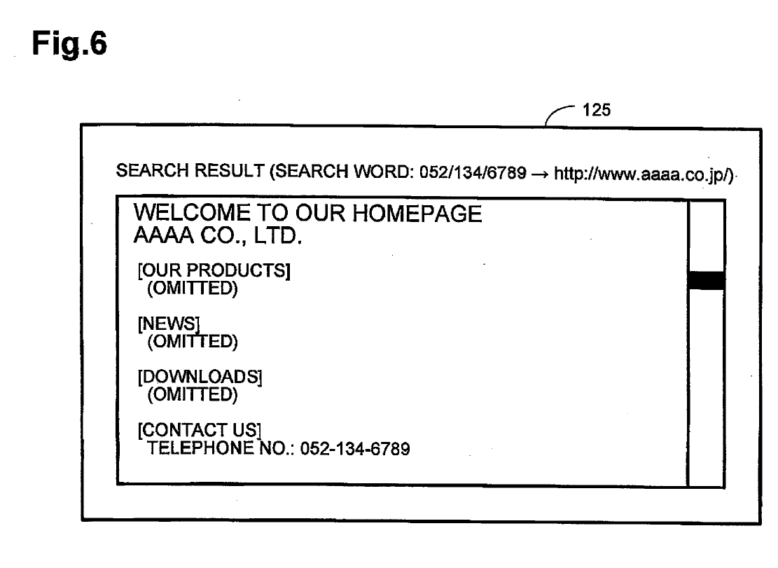

After search results are displayed at S212 (see FIG. 4), the CPU 103 waits until a user selects a specific website from the search results through the operating panel 127 (S214:NO). When the user selects a specific website through the operation panel 127 (S214:YES), the CPU 103 makes access to the selected website and displays data, which is transmitted from the selected website in response to the access to the website, on the display 125 (S216). For example, when a topmost item of a website of AAAA Co. Ltd. displayed in the search results is selected (S214:YES), the CPU 103 makes access to the selected website based on an URL (http://www.aaaa.co.jp/) of the website of AAAA Co. Ltd. and displays data, which is transmitted from the selected website in response to the access to the website, on the display 125, as shown in FIG. 6 (S216).

As described above, the user's selection is required to make access to a desired website. Alternatively, for example, the multifunctional machine 1 may be configured to automatically make access to a topmost item of a website displayed in search results. In this case, a desired website, that is, a name and other information of a desired party related to a telephone number inputted into the RAM 107 may be instantly displayed.

Optionally, after execution of S202 or S216, similar to S114 of FIG. 3, an outgoing call may be made or an incoming call may be notified (S218).

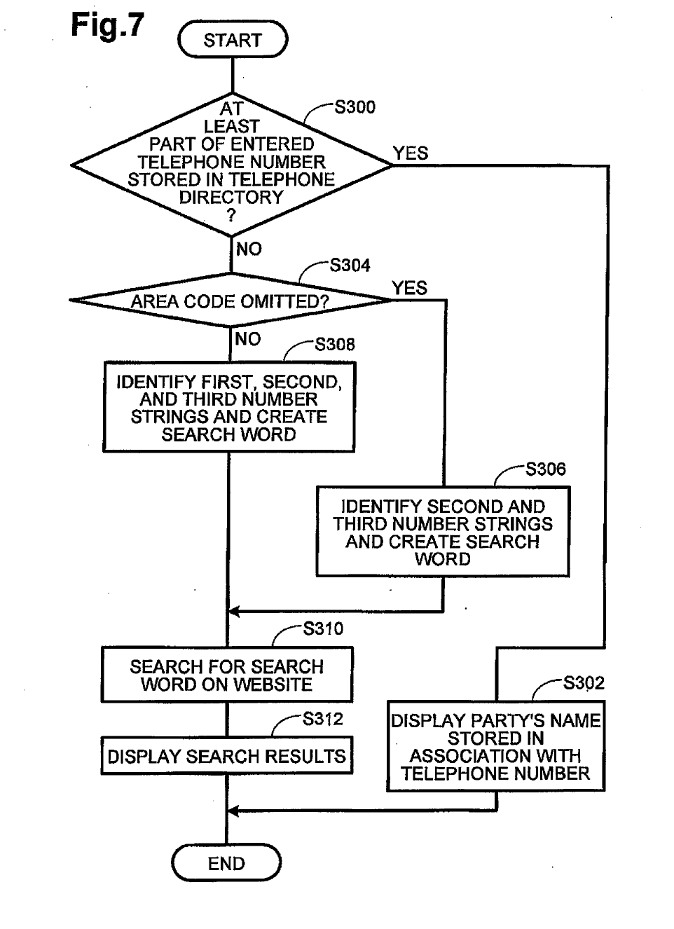

Referring to FIG. 7, processing to be performed by a CPU of a multifunctional machine according to a third embodiment of the invention will be described. The multifunctional machine according to the third embodiment has the same structure as the multifunctional machine 1 according to the first embodiment although performs processing that is partially different from the processing of FIG. 3 to be performed by the multifunctional machine 1 according to the first embodiment. Accordingly, like parts and components are designated by the same reference numerals to avoid duplicate descriptions.

First, a CPU 103 of a multifunctional machine 1 performs the processing of S300, S302 and S304, which are the same as those of S100, S102 and S104 of FIG. 3.

At S304, when the CPU 103 makes an affirmative determination (S304:YES), flow moves to S306. When the CPU 103 makes a negative determination (S304:NO), flow moves to S308. The processing of S308 is the same as that of S108 of FIG. 3.

At S306, the CPU 103 performs the same processing as S308 (see S100 of FIG. 3). That is, the CPU 103 identifies a third number string corresponding to a subscriber number from a telephone number stored in the RAM 107. More specifically, the CPU 103 identifies the last four digits of the telephone number stored in the RAM 107 as the third number string.

Then, the CPU 103 identifies the remainder of the telephone number, that is, the number that is not identified as the third number string, as a second number string corresponding to a local number.

At S310, the CPU 103 reads out the URL of the search engine 90 from the EEPROM 109 and transmits number strings corresponding to the second and third number strings identified at S306 or number strings corresponding to the first, second and third number strings identified at S308 to the search engine 90 identified by the URL, as a search word. Then, the CPU 103 receives search results from the search engine 90 in response to the transmission of the search word, and flow moves to S312.

The search results display processing to be performed by the receipt of the search results (S312) is the same as that to be performed at S112 of FIG. 3. The display manner of the search results according to the second embodiment may be adopted in the third embodiment.

Optionally, after execution of S302 or S312, similar to S114 of FIG. 3 or S218 of FIG. 5, an outgoing call may be made or an incoming call may be notified (S314).

In some illustrative embodiments, a telephone device may include an input unit through which a telephone number is inputted, main storage configured to store the telephone number inputted through the input unit, a processor configured to identify a first number string corresponding to an area code, a second number string corresponding to a local number, and a third number string corresponding to a subscriber number, from the telephone number stored in the main storage, transmit number strings corresponding to the first, second and third number strings as a search word to a search engine on the Internet, and receive a search result according to the transmitted search word, and an output unit configured to output the received search result.

Accordingly, the telephone device configured to precisely output party's information according to the inputted telephone number when making or receiving a call, may be obtained.

Further, the search word that is consistent with an indication manner of telephone numbers displayed on websites on the Internet, may be created.

In some illustrative embodiments, a telephone device may include an input unit through which a telephone number is inputted, main storage configured to store the telephone number inputted through the input unit, a processor configured to identify a first number string corresponding to an area code, a second number string corresponding to a local number, and a third number string corresponding to a subscriber number, from the telephone number stored in the main storage, transmit number strings corresponding to the first, second and third number strings as a search word to a search engine on the Internet, make access to a website according to address information identified by a search result based on the transmitted search word, and receive the search result and data transmitted from the website, and an output unit configured to output the received data.

Accordingly, the telephone device configured to precisely output detailed party's information according to the inputted telephone number when making or receiving a call, may be obtained.

Further, the search word that is consistent with an indication manner of telephone numbers displayed on websites on the Internet, may be created.

In some illustrative embodiments, the telephone device may include first auxiliary storage configured to store an area code of an area where the telephone device is installed. In the telephone device, the processor may be configured to determine whether the area code is omitted from the telephone number inputted through the input unit, and define the area code stored in the first auxiliary storage as the first number string when it is determined that the area code is omitted from the telephone number inputted through the input unit.

With this structure, the telephone device configured to precisely output party's information according to an inputted telephone number when making or receiving a call, regardless of an inputting manner of a telephone number, may be obtained.

Further, the number of number strings, which are used as a search word and are identifiable from an inputted telephone number, may be increased.

In some illustrative embodiments, a telephone device may include an input unit through which a telephone number is inputted, main storage configured to store the telephone number inputted through the input unit, a processor configured to identify a second number string corresponding to a local number and a third number string corresponding to a subscriber number, from the telephone number stored in the main storage, transmit number strings corresponding to the second and third number strings as a search word to a search engine on the Internet, and receive a search result according to the transmitted search word, and an output unit configured to output the received search result.

With this structure, the telephone device configured to precisely output party's information according to the inputted telephone number when making or receiving a call, may be obtained.

Further, the search word that is consistent with an indication manner of telephone numbers displayed on websites on the Internet, may be created.

In some illustrative embodiments, a telephone device may include an input unit through which a telephone number is inputted, main storage configured to store the telephone number inputted through the input unit, a processor configured to identify a second number string corresponding to a local number and a third number string corresponding to a subscriber number, from the telephone number stored in the main storage, transmit number strings corresponding to the second and third number strings as a search word to a search engine on the Internet, make access to a website according to address information identified by a search result based on the transmitted search word, and receive the search result and data transmitted from the website, and an output unit configured to output the received data.

With this structure, the telephone device configured to precisely output party's information according to the inputted telephone number when making or receiving a call, may be obtained.

Further, the search word that is consistent with an indication manner of telephone numbers displayed on websites on the Internet, may be created.

In some illustrative embodiments, the telephone device may be configured to make a call based on the telephone number stored in the main storage on condition that the output is performed by the output unit when the telephone number inputted through the input device is inputted by user's operation for an outgoing call.

With this structure, a user may avoid making a call to an undesired party, that is, a wrong call.

Further, the telephone device may provide information of a desired party with the user when the user makes a call.

In some illustrative embodiments, the telephone device may be configured to notify an incoming call on condition that the output is performed by the output unit when the telephone number inputted through the input device is inputted by transmission of the telephone number from an exchange.

With this structure, the user may answer a phone after identified a party (i.e. a caller).

Further, the telephone device may provide information of a party (i.e. a caller) when notifying an incoming call to the user.

In some illustrative embodiments, the telephone device may further include second auxiliary storage configured to store the telephone number and a name related to the telephone number in association with each other. In the telephone device, the processor may be further configured to determine whether a telephone number including at least a part of the telephone number stored in the main storage is stored in the second auxiliary storage, and prohibit the transmission of the number strings when it is determined that the telephone number including at least a part of the telephone number stored in the main storage is stored in the second auxiliary storage. The output device may be further configured to output the name corresponding to the telephone number including at least a part of the telephone number stored in the main storage when it is determined that the telephone number including at least a part of the telephone number stored in the main storage is stored in the second auxiliary storage.

With this structure, the efficiency of processing to be performed in the telephone device may be increased. The telephone device may control a network traffic as one of units constituting a network system.

Further, the duplicate output of party's information to the output unit may be avoided. Because the transmission of the number strings to the network is prohibited, the amount of data flowing on the network may be restricted.

The components and units constituting the telephone device according to the invention may be physically integrated with each other or may be physically separated from each other. The telephone device including the above-described components and units may be directly or indirectly connected to the public communication line.

What is claimed is:

1. A telephone device comprising:
an input unit through which a telephone number is inputted;
main storage configured to store the telephone number inputted through the input unit;
a processor configured to:
identify a first number string corresponding to an area code, a second number string corresponding to a local number, and a third number string corresponding to a subscriber number, from the telephone number stored in the main storage;
transmit number strings corresponding to the first, second and third number strings as a search word to a search engine on the Internet; and
receive a search result according to the transmitted search word; and
an output unit configured to output the received search result.

2. The telephone device according to claim 1, further comprising first auxiliary storage configured to store an area code of an area where the telephone device is installed,
wherein the processor is further configured to:
determine whether the area code is omitted from the telephone number inputted through the input unit; and
define the area code stored in the first auxiliary storage as the first number string when it is determined that the area code is omitted from the telephone number inputted through the input unit.

3. The telephone device according to claim 1, wherein the telephone device is configured to make a call based on the telephone number stored in the main storage on condition that the output is performed by the output unit when the telephone number inputted through the input device is inputted by user's operation for an outgoing call.

4. The telephone device according to claim 1, wherein the telephone device is configured to notify an incoming call on condition that the output is performed by the output unit when the telephone number inputted through the input device is inputted by transmission of the telephone number from an exchange.

5. The telephone device according to claim 1, further comprising second auxiliary storage configured to store the telephone number and a name related to the telephone number in association with each other,
wherein the processor is further configured to.
determine whether a telephone number including at least a part of the telephone number stored in the main storage is stored in the second auxiliary storage; and
prohibit the transmission of the number strings when it is determined that the telephone number including at least a part of the telephone number stored in the main storage is stored in the second auxiliary storage, and
the output device is further configured to output the name corresponding to the telephone number including at least a part of the telephone number stored in the main storage when it is determined that the telephone number including at least a part of the telephone number stored in the main storage is stored in the second auxiliary storage.

6. A telephone device comprising:
an input unit through which a telephone number is inputted;
main storage configured to store the telephone number inputted through the input unit;
a processor configured to:
identify a first number string corresponding to an area code, a second number string corresponding to a local number, and a third number string corresponding to a subscriber number, from the telephone number stored in the main storage;
transmit number strings corresponding to the first, second and third number strings as a search word to a search engine on the Internet;
make access to a website according to address information identified by a search result based on the transmitted search word; and
receive the search result and data transmitted from the website; and
an output unit configured to output the received data.

7. The telephone device according to claim 6, further comprising first auxiliary storage configured to store an area code of an area where the telephone device is installed,
wherein the processor is further configured to:
determine whether the area code is omitted from the telephone number inputted through the input unit; and
define the area code stored in the first auxiliary storage as the first number string when it is determined that the area code is omitted from the telephone number inputted through the input unit.

8. The telephone device according to claim 6, wherein the telephone device is configured to make a call based on the telephone number stored in the main storage on condition that the output is performed by the output unit when the telephone number inputted through the input device is inputted by user's operation for an outgoing call.

9. The telephone device according to claim 6, wherein the telephone device is configured to notify an incoming call on condition that the output is performed by the output unit when the telephone number inputted through the input device is inputted by transmission of the telephone number from an exchange.

10. The telephone device according to claim 6, further comprising second auxiliary storage configured to store the telephone number and a name related to the telephone number in association with each other,
wherein the processor is further configured to:
determine whether a telephone number including at least a part of the telephone number stored in the main storage is stored in the second auxiliary storage; and
prohibit the transmission of the number strings when it is determined that the telephone number including at least a part of the telephone number stored in the main storage is stored in the second auxiliary storage, and
the output device is further configured to output the name corresponding to the telephone number including at least a part of the telephone number stored in the main storage when it is determined that the telephone number including at least a part of the telephone number stored in the main storage is stored in the second auxiliary storage.

11. A telephone device comprising:
an input unit through which a telephone number is inputted;
main storage configured to store the telephone number inputted through the input unit;
a processor configured to:
identify a second number string corresponding to a local number and a third number string corresponding to a subscriber number, from the telephone number stored in the main storage;
transmit number strings corresponding to the second and third number strings as a search word to a search engine on the Internet; and
receive a search result according to the transmitted search word; and
an output unit configured to output the received search result.

12. The telephone device according to claim 11, wherein the telephone device is configured to make a call based on the telephone number stored in the main storage on condition that the output is performed by the output unit when the telephone number inputted through the input device is inputted by user's operation for an outgoing call.

13. The telephone device according to claim 11, wherein the telephone device is configured to notify an incoming call on condition that the output is performed by the output unit when the telephone number inputted through the input device is inputted by transmission of the telephone number from an exchange.

14. The telephone device according to claim 11, further comprising auxiliary storage configured to store the telephone number and a name related to the telephone number in association with each other,
wherein the processor is further configured to:
determine whether a telephone number including at least a part of the telephone number stored in the main storage is stored in the auxiliary storage; and
prohibit the transmission of the number strings when it is determined that the telephone number including at least a part of the telephone number stored in the main storage is stored in the auxiliary storage, and
the output device is further configured to output the name corresponding to the telephone number including at least a part of the telephone number stored in the main storage when it is determined that the telephone number including at least a part of the telephone number stored in the main storage is stored in the auxiliary storage.

15. A telephone device comprising:
an input unit through which a telephone number is inputted;
main storage configured to store the telephone number inputted through the input unit;
a processor configured to:
identify a second number string corresponding to a local number and a third number string corresponding to a subscriber number, from the telephone number stored in the main storage;
transmit number strings corresponding to the second and third number strings as a search word to a search engine on the Internet;
make access to a website according to address information identified by a search result based on the transmitted search word; and
receive the search result and data transmitted from the website; and
an output unit configured to output the received data.

16. The telephone device according to claim 15, wherein the telephone device is configured to make a call based on the telephone number stored in the main storage on condition that the output is performed by the output unit when the telephone number inputted through the input device is inputted by user's operation for an outgoing call.

17. The telephone device according to claim 15, wherein the telephone device is configured to notify an incoming call on condition that the output is performed by the output unit when the telephone number inputted through the input device is inputted by transmission of the telephone number from an exchange.

18. The telephone device according to claim 15, further comprising auxiliary storage configured to store the telephone number and a name related to the telephone number in association with each other,
wherein the processor is further configured to:
determine whether a telephone number including at least a part of the telephone number stored in the main storage is stored in the auxiliary storage; and
prohibit the transmission of the number strings when it is determined that the telephone number including at least a part of the telephone number stored in the main storage is stored in the auxiliary storage, and
the output device is further configured to output the name corresponding to the telephone number including at least a part of the telephone number stored in the main storage when it is determined that the telephone number including at least a part of the telephone number stored in the main storage is stored in the auxiliary storage.
